(19) United States
(12) Patent Application Publication
(10) Pub. No.: US 2009/0110120 A1
(43) Pub. Date: Apr. 30, 2009

(54) WIRELESS COMMUNICATIONS APPARATUS

(75) Inventors: Darren Phillip MCNAMARA, Bristol (GB); Andrew George LILLIE, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/253,583

(22) Filed: Oct. 17, 2008

(30) Foreign Application Priority Data
Oct. 18, 2007 (GB) 0720455.5

(51) Int. Cl. H04L 27/06

(52) U.S. Cl. 375/340

(57) ABSTRACT

Lattice reduction aided MIMO detection is disclosed for a packet based signal comprising a header and one or more data symbols. The detector comprises a pre-processing section operable to derive channel decoding information on the basis of a channel estimate from the header, storage means operable to store the channel decoding information, and a data processing section operable to process the one or more data symbols with reference to the stored channel decoding information.

The present invention is concerned with the provision of a MIMO detector.

MIMO detectors are required in a variety of devices implementing MIMO technology. Examples of such devices can include mobile telephones, base stations for use in establishing a local wireless network, or WLAN devices.

Narrowband MIMO communication systems are commonly modelled by the following equation:

y=Hx+n (1)

where y and n are Nᵣₓ-by-1 vectors, x is an Nₜₓ-by-1 vector and H is an Nᵣₓ-by-Nₜₓ matrix. y represents the received signal, n is additive noise, x the transmitted signal and H the channel response matrix. The challenge facing a designer of a MIMO detector is to establish a way of estimating x given the observation y and knowledge of the channel response, H.

Generally, an estimate of the channel response H can be determined by considering the condition of information received in a portion of a packet when the receiver is already aware of the condition of the information as transmitted. This is a well established technique using a predetermined preamble which can be detected by a receiver and from this a channel estimate can, in theory at least, be determined.

Various algorithms exist for MIMO detectors. These all vary in their performance and complexity. Common choices for implementation are the zero-forcing (ZF) or minimum mean square error (MMSE) solutions, due to their practicability. Non-linear detectors offer higher performance, although the complexity of the optimal maximum likelihood (ML) solution is usually prohibitively high in all but the most trivial system configurations. There is therefore significant motivation to use a sub-optimum detector that can achieve a good performance gain over the linear ZF or MMSE solutions whilst still being able to be implemented in a practical device.

The model for a ZF detector is:

\hat{x}=H⁻¹y (2)

where x is the estimated detected transmitted symbol. QR decomposition is employed in matrix calculations to simplify individual stages in the calculation. It offers opportunities for stages to be approximated, as appropriate, in order to reduce computational complexity. In connection with MIMO decoding, H can be decomposed such that:

H=QR (3)

where R is upper triangular (i.e. all elements beneath the diagonal are zero) and Q is orthonormal (i.e. the product of Q and its Hermitian transpose is equal to the identity matrix). Therefore:

Q^{H}Q=I (4)

With the knowledge of these properties, the relationship in equation (2) can be re-expressed as:

\hat{x}=R⁻¹Q^{H}y (5)

To improve performance from that of a ZF or MMSE MIMO detector, a number of papers disclose the use of Lattice-Reduction-Aided (LRA) MIMO detectors. One description is given in “On generating soft outputs for lattice-reduction-aided MIMO detection” (V. Ponnampalam, D. McNamara, A. Lillie and M. Sandell; Proceedings of International Conference on Communications, June 2007), along with a method of obtaining soft-output. This method of soft output is also disclosed in GB2429884A1. Lattice-reduction-aided (LRA) MIMO detectors can offer performance close to that of ML detectors, such as considered in Ponnampalam et al. That approach achieved greatly reduced complexity when compared with the theoretically optimum detector.

The following publications are noted as background information:
H. Yao and G. W. Wornell, “Lattice-Reduction-Aided Detectors for MIMO Communication Systems”, in Proc. IEEE Globecom, November 2002, pp. 424-428;

C. Windpassinger and R. Fischer, “Low-Complexity Near-Maximum-Likelihood Detection and Precoding for MIMO Systems using Lattice Reduction”, in Proc. IEEE Information Theory Workshop, Paris, March, 2003, pp. 346-348;

I. Berenguer, J. Adeane, I. Wassell and X. Wang, “Lattice-Reduction-Aided Receivers for MIMO-OFDM in Spatial Multiplexing Systems”, in Proc. Int. Symp. on Personal Indoor and Mobile Radio Communications, September 2004, pp. 1517-1521;

D. Wubben, R. Bohnke, V. Kuhn and K. Kammeyer, “MMSE-Based Lattice-Reduction for Near-ML Detection of MIMO Systems”, in Proc. ITG Workshop on Smart Antennas, 2004.

These four documents describe how lattice reduction can be employed to enhance the performance of a ZF or MMSE MIMO detector, yielding a LRA MIMO detector. Windpassinger et al. also describes how lattice reduction can be applied to pre-coding, which is a very similar problem. These papers give an algorithmic view of how lattice reduction can be performed and employed for MIMO detection. “Factoring Polynomials with Rational Coefficients” (A. Lenstra, H. Lenstra and L. Lovasz, Math Ann., Vol. 261, pp. 515-534, 1982) introduces the Lenstra Lenstra Lovasz (LLL) algorithm. It is generally assumed that the LLL algorithm is employed to perform the lattice reduction, although any appropriate algorithm could be employed. The LLL algorithm is iterative and has variable complexity. Complexity is dependent upon a number of different parameters, as discussed in “Complexity study of lattice reduction for MIMO detection” (M. Sandell, A. Lillie, D. McNamara, V. Ponnampalam and D. Milford, In Proc. IEEE Globecom 2007). As noted and discussed in that document, the LLL algorithm, modified for the lattice reduction of complex matrices, is as follows:

Given a QR decomposition of the m×n channel matrix, H=QR, do the lattice reduction:

INPUT: Q, R, P (default P = Iₘ)
OUTPUT: \tilde{Q}, \tilde{R}, T

| | |
|---|---|
| (1) | Initialisation: \tilde{Q} = Q, \tilde{R} = R, T = P |
| (2) | k = 2 |
| (3) | while k ≦ m |

| | |
|---|---|
| (4) | for l = k − 1, . . . , 1 |

| | |
|---|---|
| (5) | μ = [symbol] \tilde{R}(l, k)/\tilde{R}(l, l) [symbol] |
| (6) | if μ ≠ 0 |

| | |
|---|---|
| (7) | \tilde{R}(1:l, k) = \tilde{R}(1:l, k) − μ\tilde{R}(1:l, l) |
| (8) | T(;, k) = T(:, k) − μT(:.l) |

| | |
|---|---|
| (9) | end |

| | |
|---|---|
| (10) | end |
| (11) | if \|δ\tilde{R}(k − 1, k − 1)²\| > \|\tilde{R}(k, k)²\| + \|\tilde{R}(k − 1, k)²\| |

| | |
|---|---|
| (12) | swap columns k − 1 and k in \tilde{R} and T |
| (13) | calculate Givens rotation matrix Θ such that |
| | element \tilde{R}(k, k − 1) becomes zero: |
| | $Θ = ( \begin{matrix}{a}^{*} & {b}^{*} \\ - b & a\end{matrix} ) with \begin{matrix}a = \frac{\tilde{R} ( k - 1 , k - 1 )}{‖ \tilde{R} ( k - 1 \text{:} k , k - 1 ) ‖} \\ b = \frac{\tilde{R} ( k , k - 1 )}{‖ \tilde{R} ( k - 1 \text{:} k , k - 1 ) ‖}\end{matrix}$ |
| (14) | \tilde{R}(k − 1:k, k − 1:m) = Θ\tilde{R}(k − 1:k, k − 1:m) |
| (15) | \tilde{Q}(:, k − 1:k) = \tilde{Q}(:, k − 1:k)Θ^{H} |
| (16) | k = max{k − 1, 2} |

| | |
|---|---|
| (17) | else |

| | |
|---|---|
| (18) | k = k + 1 |

| | |
|---|---|
| (19) | end |

| | |
|---|---|
| (20) | end |

Note that δ = 3/4 in Wubben et al. and that [symbol] x [symbol] denotes the nearest integer to x.

One of the initial obstacles standing in the way of adopting LRA detectors was the absence of a feasible algorithm for obtaining soft output. Soft output can be described as probability information describing the relative likelihoods of a particular transmitted bit having a particular value, rather than an absolute “hard” output. The advantage of presenting a soft output for use by the receiver is that the probability information informs the next stage of the receiver as to the level of confidence to apply to the detected data and decisions can then be taken as to the extent to which information should be relied upon, or if re-transmission should be requested. This provides greater flexibility in terms of incorporating such a device into a real and working system. Thus, a “soft output” detector is attractive to receiver designers, and a solution to this is disclosed in GB2429884A1, in the Ponnampalam et al. document referred to above, and in US2007/0206697A1.

The hardware implementation of linear ZF or MMSE detectors is often based on the QR-decomposition method. An example of this is described in “Reconfigurable antenna processing with matrix decomposition using FPGA based application specific integrated processors” by M. P. Fitton, S. Perry and R. Jackson, and to be found at www.altera.com/literature/cp/milaero/antenna-processing.pdf. As described in Fitton et al., this can be efficiently implemented through the use of a CORDIC process. Although Fitton et al. only describes a ZF solution, the same method can be used to implement an MMSE solution by assuming an extended system model of the channel matrix as described in Wubben et al.

According to an aspect of the invention, a lattice reduction aided MIMO detector is operable to detect information in a packet based signal comprising a header and one or more data symbols, the detector comprising a pre-processing section operable to derive channel decoding information on the basis of a channel estimate from said header, storage means operable to store said channel decoding information, and a data processing section operable to process said one or more data symbols with reference to said stored channel decoding information.

Another aspect of the invention provides a method of detecting information in a packet based signal comprising a header and one or more data symbols, the method comprising pre-processing, said pre-processing including deriving channel decoding information on the basis of a channel estimate from said header, said channel decoding information enabling equalisation of data symbols in a reduced lattice, storing said channel decoding information, and processing said one or more data symbols with reference to said stored channel decoding information.

According to an aspect of the invention, there is provided a lattice reduction aided MIMO detector operable to detect a signal, the detector comprising a pre-processing section that is executed once per received packet, and a data-processing section that is possibly executed multiple times per packet.

The pre-processing section may apply a QR decomposition to the channel matrix, H; it performs lattice reduction based on the R matrix output from this QR decomposition to produce HT; it then applies a QR decomposition to HT, producing CORDIC control signals for applying the Q^{H} rotation in the data-processing section and the corresponding R matrix for applying back-substitution in the data-processing section.

Another aspect of the invention provides a method of employing an inner feedback loop so that a single lattice reduction processor can be used to perform lattice reduction.

Another aspect of the invention provides a method of employing an outer feedback loop from the lattice reduction processor to the QR decomposition processor so that a single QR decomposition engine can be employed within the pre-processing engine.

Another aspect of the invention provides a method of interleaving feed forward and feedback data at the lattice reduction processor input.

Another aspect of the invention provides a method of optimising rate matching and pipeline length to facilitate contention free feed forward and feedback connections between the QR decomposition and lattice reduction processors.

Another aspect of the invention provides a method of reducing the complexity of the LLL lattice reduction algorithm and optimizing it for hardware implementation by modifying the range of the T matrix update value.

Another aspect of the invention provides a method of limiting or constraining the range of the lattice reduction update parameter that significantly reduces the complexity of a hardware unit required for its implementation without negatively impacting performance. The update parameter may be constrained to a finite set of values. the update parameter may be constrained to be positive or negative unity, or zero. Such a hardware processing unit may be capable of computing the above limited update parameter using only simple numerical and logical operations. The invention according to this aspect may provide an extended hardware processing unit capable of applying the above limited update parameter.

Another aspect of the invention provides a hardware implementation of a lattice-reduction-aided MIMO detector, in which latency can be reduced through the calculation of the matrix product, HT, as an update process during lattice reduction processing.

Another aspect of the invention provides a method of modifying a lattice reduction algorithm to additionally output the matrix product of the lattice reduction matrix T and the input matrix H to be reduced.

Another aspect of the invention provides a method for simple hardware implementation of said modification whereby only simple addition, subtraction and column exchange operations are required.

Another aspect of the invention provides a method for switching between LRA MMSE and MMSE MIMO detection based upon received packet size and MCS mode in order to optimize receiver performance.

Another aspect of the invention provides, for a reconfigurable MIMO detector which supports LRA MMSE and MMSE detection, a method of switching between detectors based upon packet size. By this, real-time detector operation can be achieved.

In such a detector, another aspect of the invention comprises a method of switching between detectors based upon PER performance.

In such a detector, another aspect of the invention provides determining both PER performance and packet size metrics for determining detector choice.

The pre-processing section may be operable to apply a QR decomposition (QRD) to the channel matrix, H. The pre-processing section may be operable to perform lattice reduction based on the R matrix output from this QRD to produce HT which is a channel response estimate in a reduced lattice; it may then be operable to apply a QR decomposition to HT, producing CORDIC control signals for applying the Q^{H} rotation in the data-processing section and the corresponding R matrix for applying back-substitution in the data-processing section.

There are differences between the sequential execution of an algorithm in a general purpose CPU (e.g. a computer simulation or an implementation on a DSP) and how that algorithm would be implemented in hardware, either on an FPGA or an ASIC. In particular, the factors affecting decisions taken in the design of a data processing method to be implemented in hardware are different, relating for example to processing speed or reliance on “real estate” on an integrated circuit. One part of this disclosure will involve a description of an architecture for the hardware implementation of an LRA MIMO detector. This will guide the skilled person in making design decisions to enhance performance of an eventual, practical device.

Further aspects and advantages of the invention will become apparent to the reader on the basis of the following description of specific embodiments of the invention, with the benefit of the following drawings, in which:

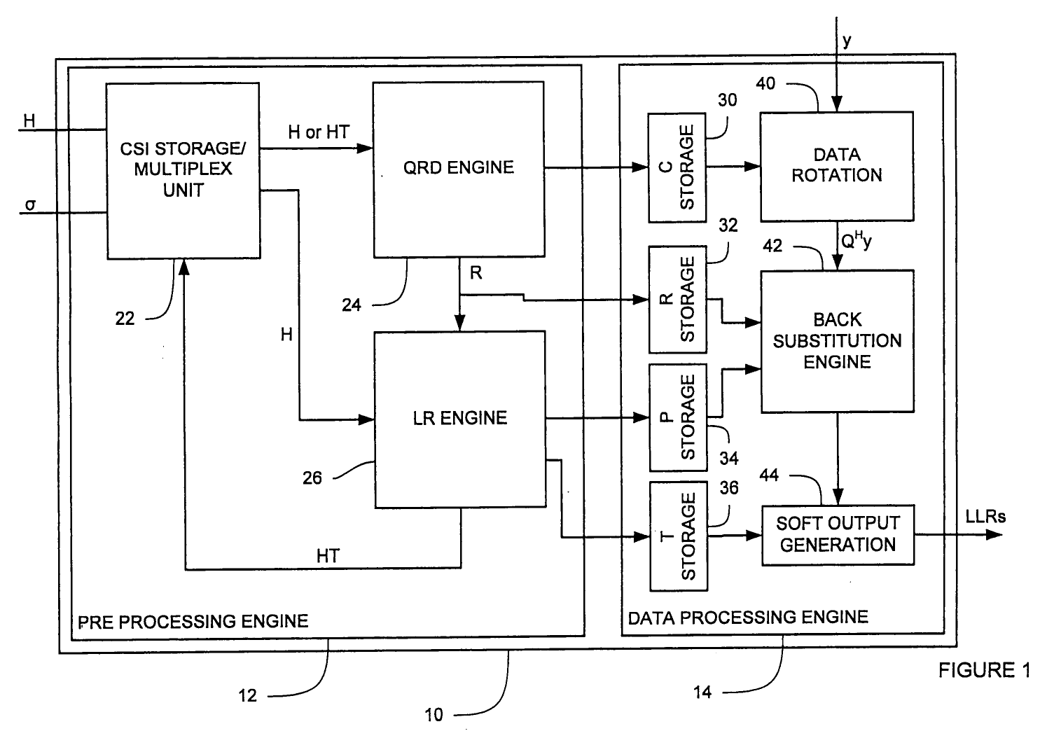

FIG. 1 illustrates schematically a MIMO detector in accordance with a first specific embodiment of the invention;

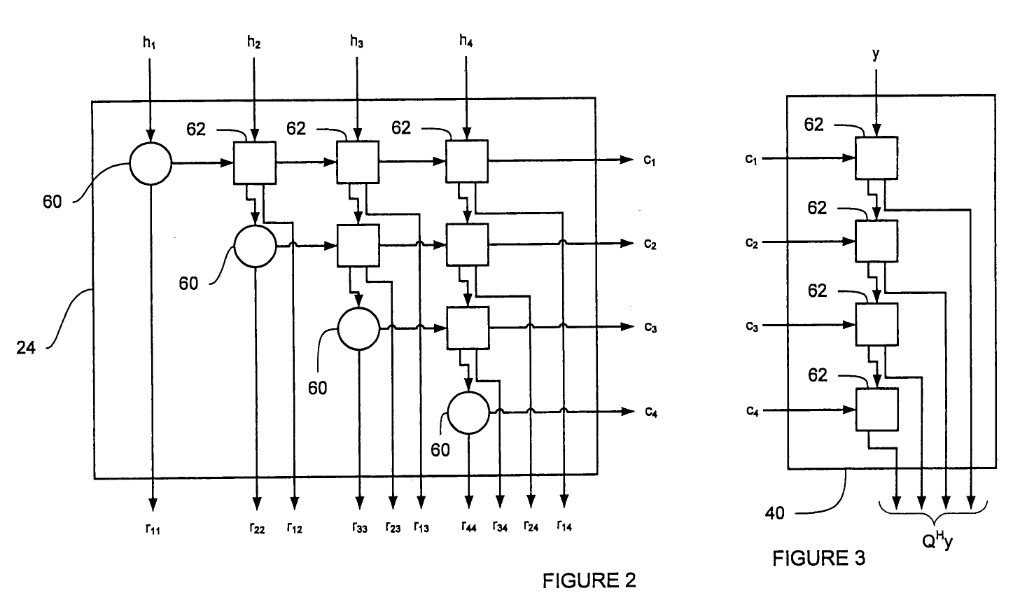

FIG. 2 illustrates, in accordance with the first embodiment of the invention, a specific implementation of a QRD engine such as shown in FIG. 1;

FIG. 3 illustrates, in accordance with the first embodiment of the invention, a specific implementation of a data rotation engine such as shown in FIG. 1;

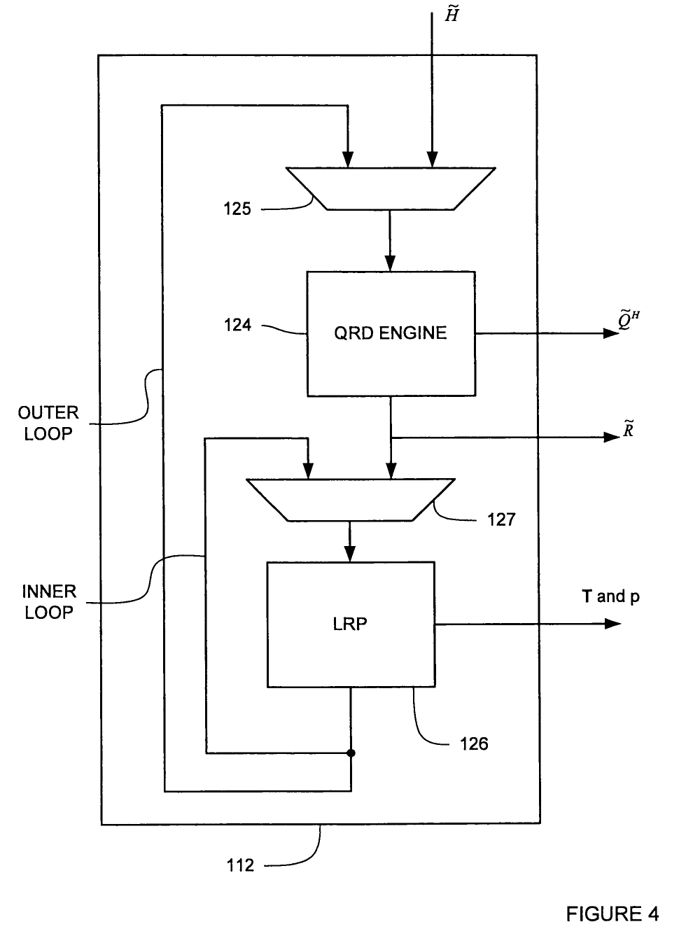

FIG. 4 illustrates, a functional representation of a lattice reduction engine in accordance with the second embodiment of the invention;

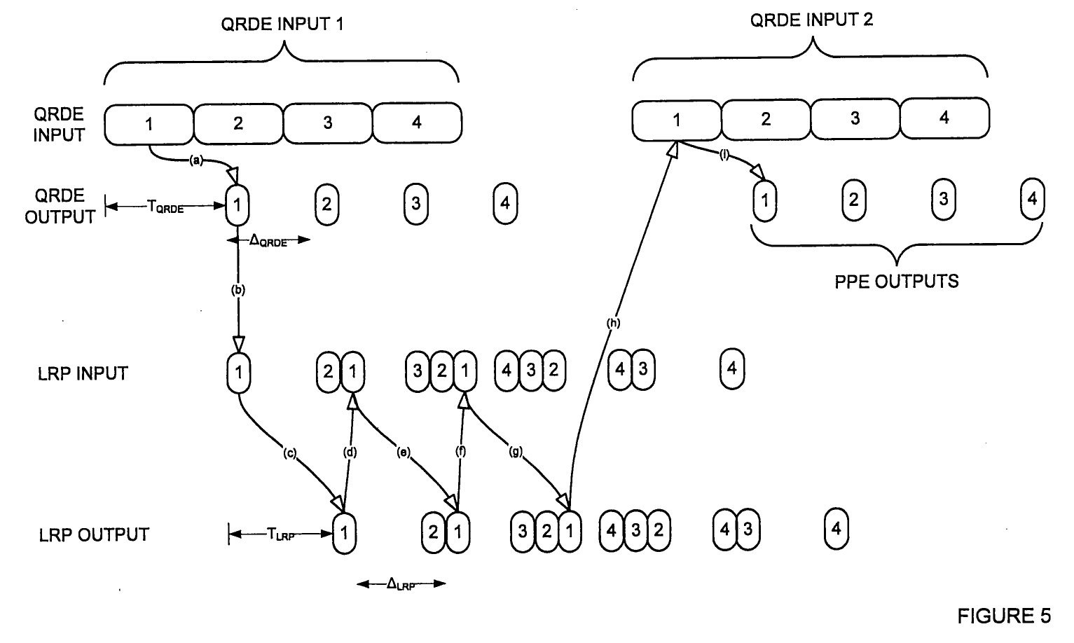

FIG. 5 illustrates a timing diagram for operation of the pre processing engine illustrated in FIG. 4;

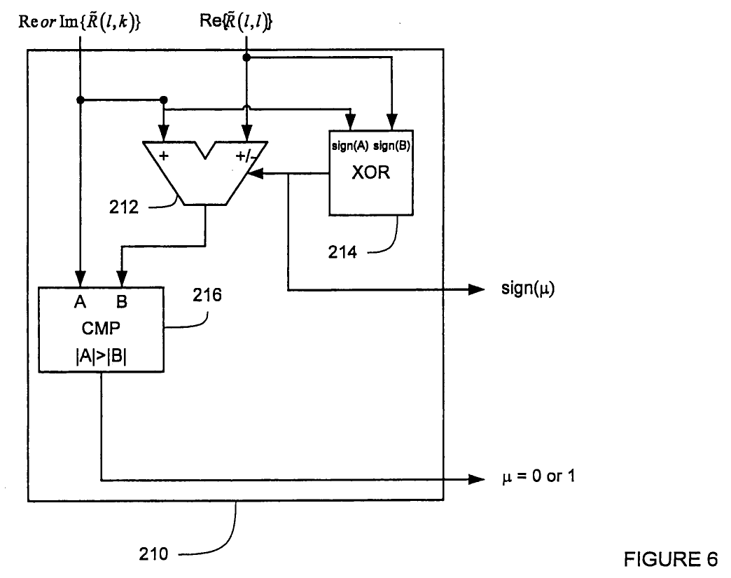

FIG. 6 illustrates schematically a hardware implementation of an update parameter unit, in accordance with a third embodiment of the invention, the update parameter unit being for use in a lattice reduction engine such as that implemented in the embodiment illustrated in FIG. 1;

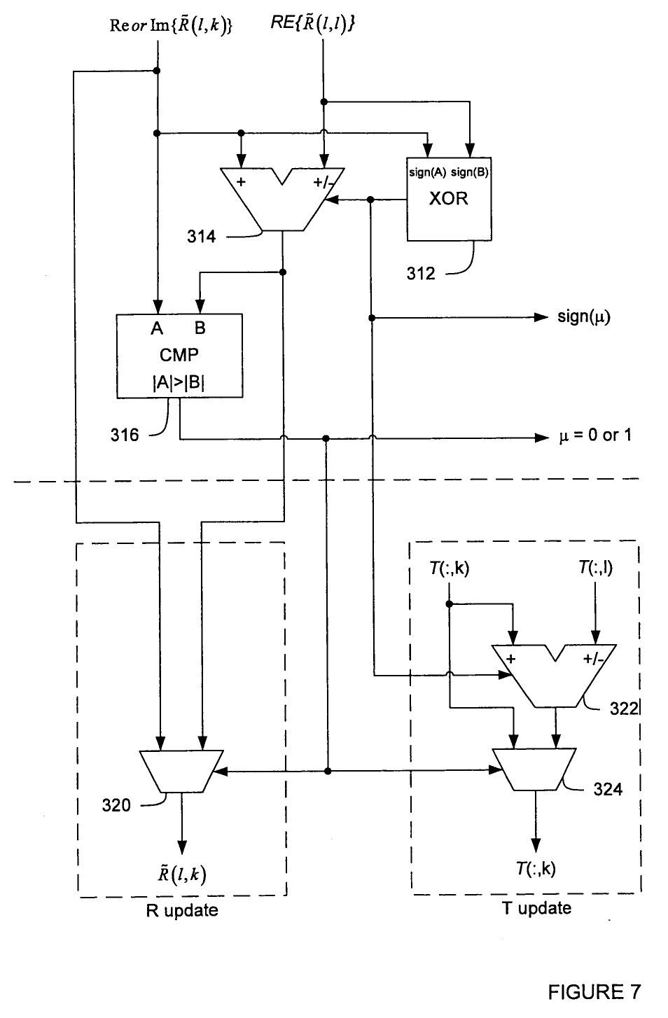

FIG. 7 illustrates schematically a hardware implementation of aspects of a lattice reduction engine, in accordance with the third embodiment, for incorporation into a detector;

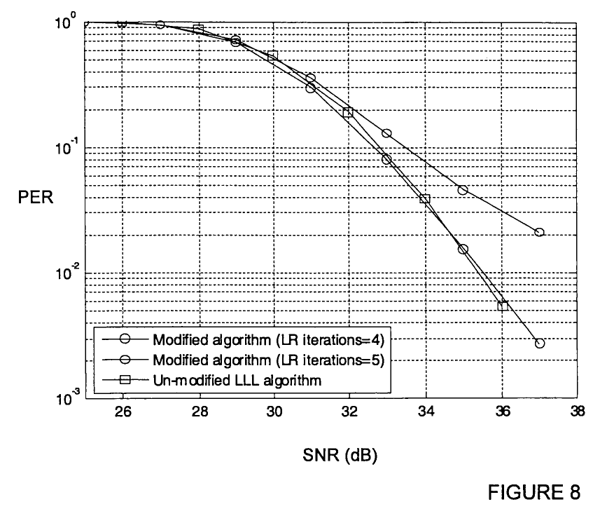

FIG. 8 illustrates a graph of packet error rate against signal to noise ratio for examples of use of the third embodiment of the invention;

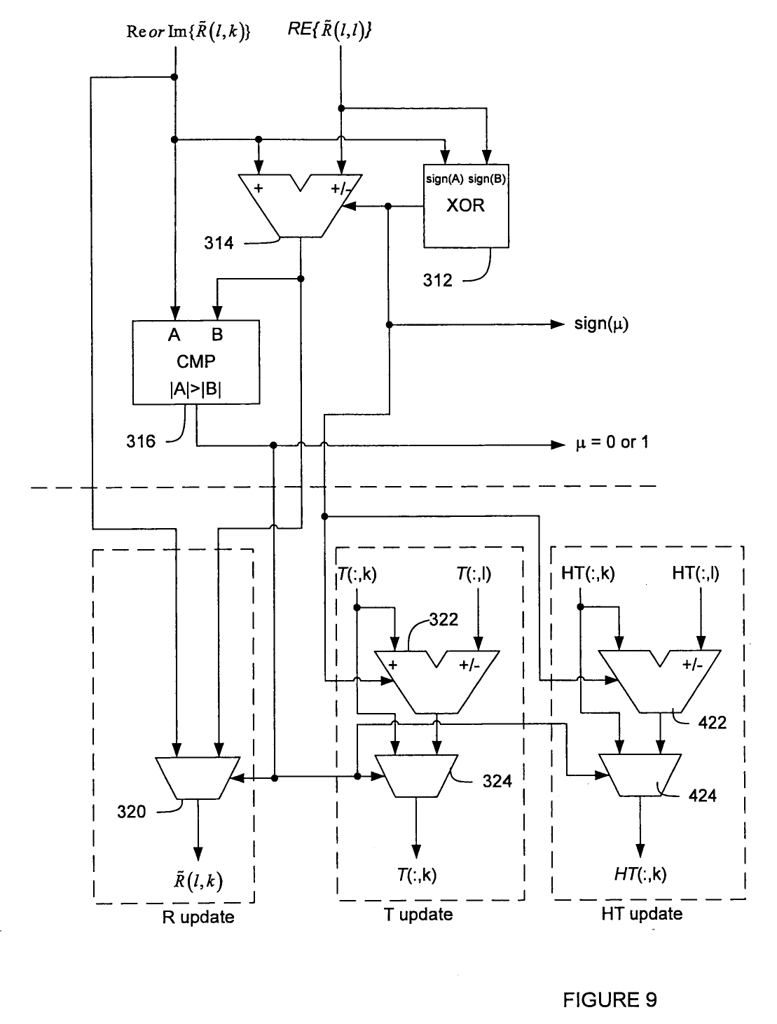

FIG. 9 illustrates schematically a hardware implementation of aspects of a lattice reduction engine, in accordance with a fourth embodiment, for incorporation into a detector;

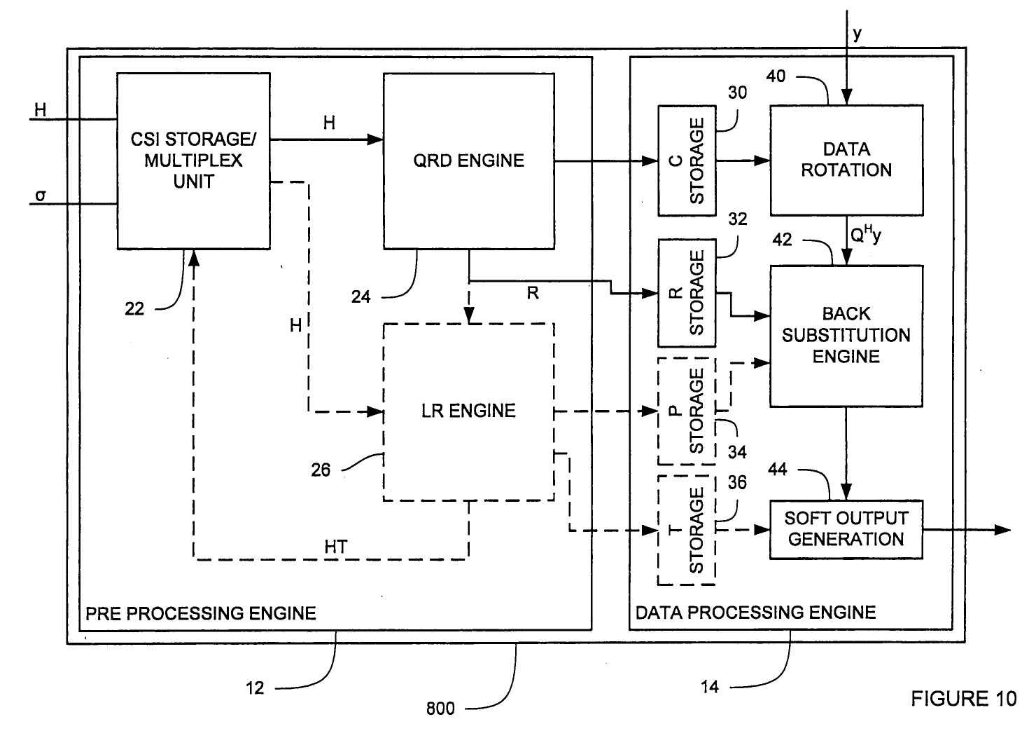

FIG. 10 illustrates schematically a MIMO detector in accordance with a fifth specific embodiment of the invention;

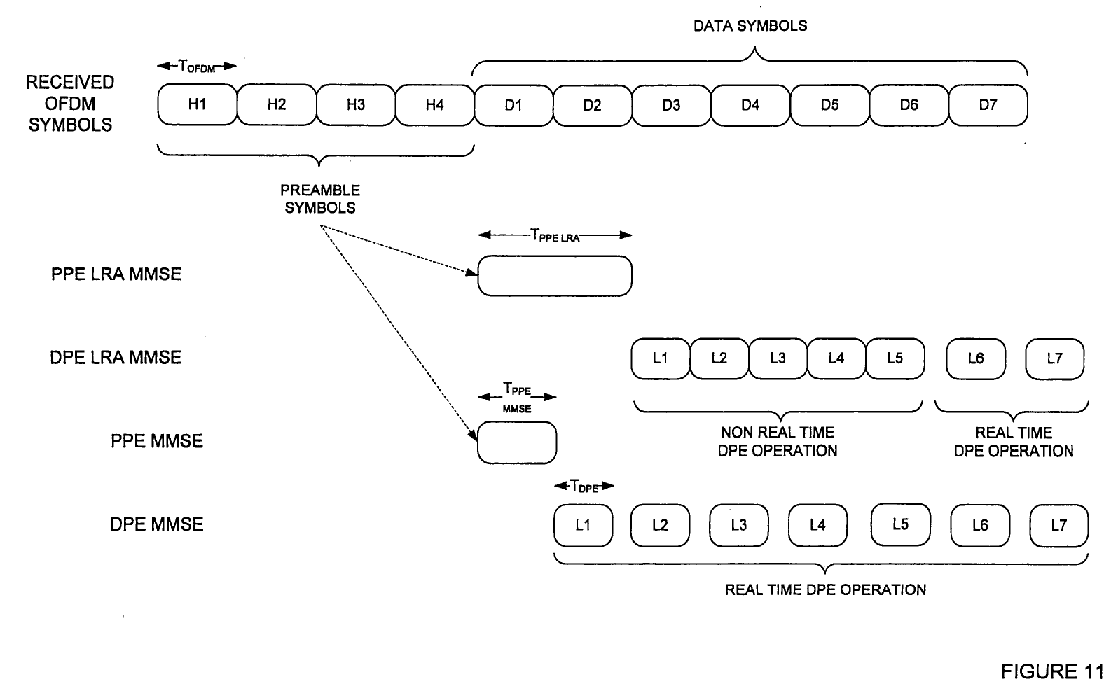

FIG. 11 illustrates a timing diagram for operation of the pre processing engine illustrated in FIG. 10; and

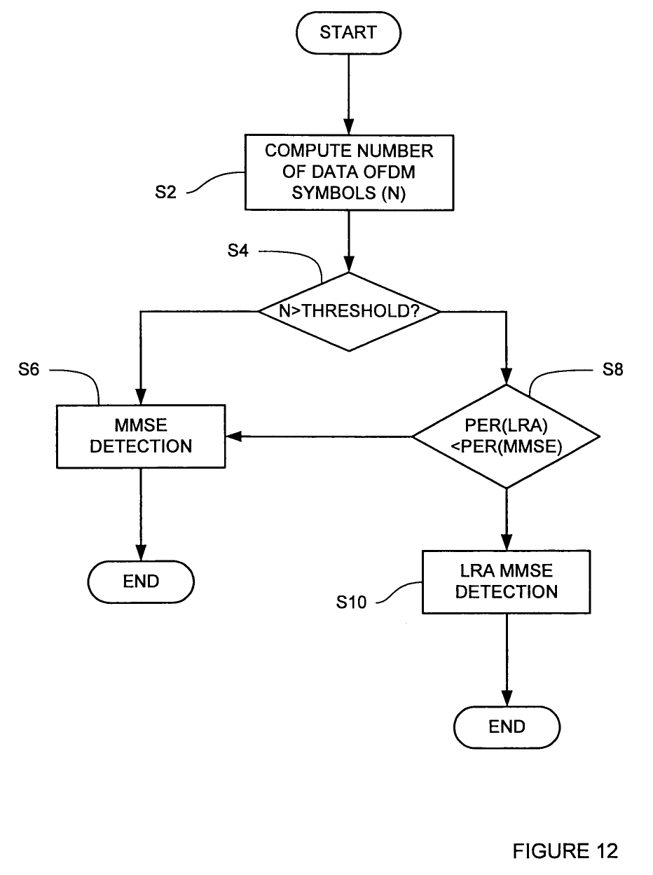

FIG. 12 illustrates a flow diagram for a process carried out by the detector of the fifth embodiment of the invention.

Referring firstly to FIG. 1, a block diagram illustrates the architecture of an LRA MIMO detector 10 in accordance with a first specific embodiment of the invention.

The detector 10 comprises two sections, namely a pre-processing engine (PPE) 12 and a data processing engine (DPE) 14. The PPE receives channel state information H and noise variance σ as inputs. It processes these to generate information and control signals for the DPE 14. Execution of the PPE 12 is only required when the inputs (H or σ) change. Typically, the detector 10 is configured to cause execution of the PPE 12 once at the start of reception of a packet.

The reason for pre-processing channel state information for each packet is that successive packets may have been received from different channels. Thus, it is unsafe to assume that channel state information and noise variance are unchanged from one packet to the next. Indeed, it can be positively expected that H and σ will change from one packet to the next in for example 802.11 WLAN systems.

In general terms, the PPE generates CORDIC control signals, denoted C, for control of data rotation operations performed by CORDIC elements of the data processing engine 14. The PPE 12 also produces as an output a matrix R, which, as discussed above, is the result of a QR-decomposition performed in the PPE 12. R is upper triangular, as previously discussed.

Although, as will be appreciated in due course, aspects of the data processing engine will be capable of implementation by the skilled reader without further specific detail, later described embodiments of the invention relate to new hardware configurations providing certain advantageous features.

The PPE 12 further generates a lattice reduction matrix T, and also presents this to the DPE 14, together with a vector P which comprises the row sum parity p of the inverse of the lattice reduction matrix T.

To do this, the PPE 12 comprises a channel state information storage/multiplex unit 22 which is operable to store and handle delivery of channel state information in the form of H, the input matrix or HT, the channel state information in a reduced lattice (defined by matrix T), to other components of the PPE 12. The PPE 12 further comprises a QR-decomposition engine 24 which takes, as an input, a channel state information matrix (either H or HT, as the case may be) and applies to this a QR-decomposition. This QRD engine 24 outputs, when required, the CORDIC control information C and the upper triangular decomposition matrix R. The upper triangular matrix R is forwarded to a lattice reduction engine 26 which is operable on the CSI matrix H, together with the upper triangular matrix R to produce the lattice reduction matrix T, the corresponding row sum parity vector p and, the channel state matrix expressed in the reduced lattice HT.

In use, the PPE 12 operates in the following manner. The operation of the PPE 12 assumes that the requisite CSI matrix H and the noise variance a have been received and stored in the CSI storage/multiplex unit 22.

The original channel state matrix H is presented to the QR-decomposition engine 24, and this applies a QR-decomposition to the input CSI matrix H. In this operation, only the output R is required. This is routed as an input to the lattice reduction engine 26.

The lattice reduction engine 26 computes a lattice matrix T, based upon the input matrix R. Any suitable implementation of a lattice reduction algorithm can be used, although in a later described embodiment, a hardware efficient implementation of the LLL algorithm will be disclosed.

The lattice reduction engine 26 outputs a matrix HT which is computed during the lattice reduction process. Again, the manner in which this is achieved in a specific embodiment will be described in due course.

The resultant T matrix is then output to the DPE 14. The row sum parity vector p is also presented to the DPE 14.

The matrix HT is then presented back to the CSI storage/multiplex unit 22, and then passed through to the QR-decomposition engine 24. It will be appreciated by the reader that this repeated use of the QR-decomposition engine 24 is for the benefit of re-use of hardware. It would equally be possible to provide a second QR-decomposition engine to process the HT matrix if this were a more suitable and convenient configuration. However, feedback of HT and reuse of the single QR-decomposition engine 24 is, in this embodiment, considered to be effective use of available hardware real-estate.

The result of QR-decomposition of HT is the production of CORDIC control signals C which will be used by the DPE 14, as will be described in due course, to apply rotations to the received signal data y. Further, the R matrix is presented to the DPE 14.

The DPE 14 will now be described in further detail. The DPE 14 comprises storage units 30 to 36 operable to store C, R, P, and T respectively. These are used by the other elements of the DPE 14 in producing log likelihood ratio information, that is, soft output information on the basis of input signal data y. A data rotation unit 40 applies, on the basis of CORDIC control information C stored in the C storage unit 30, a number of appropriate rotations to generate Q^{H}y. On the basis of Q^{H}y, a back substitution engine 42 processes this data on the basis of a back substitution process, using R and the row sums P. The back substitution process is enhanced by knowledge of p, which are the row sum parities of the inverse of the T matrix. This will enable efficient implementation of constellation shift and scale operations required by lattice reduction aided decoding.

The output of the back substitution engine is R⁻¹Q^{H}y. This is quantised and input to the soft output generation unit 44, which operates on the basis of knowledge of the T matrix supplied by the PPE 12. This soft output generation unit 44 can be an implementation of one of the algorithms described in Ponnampalam et al. However, the reader will appreciate that any other algorithm could be implemented by means of the soft output generation unit 44.

The resultant log likelihood ratios can then be output from the lattice reduction aided detector 10.

As will be seen from the foregoing description of the general architecture, the above described specific embodiment provides an architecture for an LRA MIMO detector, wherein the implementation of the algorithm is carried out on the basis of splitting the decoding algorithm into a pre-processing section executed infrequently (such as once per packet) and a data processing section executed more frequently (such as multiple times per packet).

The pre-processing engine 12 applies a QR-decomposition to an input channel matrix H, and then a lattice reduction based on the R matrix output from the QR-decomposition engine 24 to produce HT. It then applies QR-decomposition to HT, producing CORDIC control signals C for applying the Q^{H} rotation in the data processing engine 14 and the corresponding R matrix for applying back substitution in the data processing section.

FIG. 2 illustrates, in further detail, an exemplary implementation of the QRD engine 24. The arrangement comprises a systolic array, comprising a triangular arrangement of systolic node processing elements. This type of systolic array is similar to that disclosed in the above referenced paper by Fitton et al.

The systolic array is illustrated with a row of four systolic node processing elements at the top of the figure as illustrated, which take as their inputs successive rows of the channel state information matrix H, or HT, as the case may be. Then successively fewer systolic node processing elements are presented to the data resultant from the preceding row.

As was described in Fitton et al., two types of systolic node processing elements are employed. Boundary cells 60 are used to calculate the Givens rotation that is applied across a particular row in the matrix. The boundary cells 60 are illustrated as circular elements in FIG. 2.

The boundary cell of the first row of systolic node processing elements is operable to receive, successively, the elements of the first column of the input matrix H or HT (as the case may be). From this, it generates a data value r₁₁ which is the first diagonal element of the R matrix. It presents this to an internal cell 62 and then on to the remaining internal cells 62 of that row. Internal cells are indicated as square boxes in FIG. 2, and are not all labelled with reference number 62, for reasons of clarity.

Internal cells 62 apply the transform to input values and previously stored values to calculate a new value and an output. The transform is also outputted to be used by the next boundary cell in the row.

The upper triangular matrix R can be constructed from the resultant outputs rᵢⱼ of the systolic array presented in this form, together with a control vector C.

FIG. 3 illustrates in corresponding detail the structure of the data rotation unit 40 of the data processing engine 14. The data rotation unit 40 comprises a sequence of internal cells 62, the same in function as those provided in the QRD engine 24. Four cells are provided in this example, corresponding to the dimension of the R matrix, and also to the dimension of the H and HT matrices. Each cell 62 receives a control signal cₙ, and the first in the sequence receives elements of the input signal y in successive steps. Due to the pipeline nature of the data rotation unit 40, presented in this form, the data elements making up the signal vector y can be input successively, and the result pertaining to the first element does not need to be produced by the data rotation unit 40 before the second element can be input, and so on.

Each cell 62 in the pipeline, up to the penultimate cell, outputs its rotation result to the next cell in the pipeline and also to a series of outputs which present Q^{H}y to the back substitution engine 42.

It will be understood by the skilled person that this results in the minimum possible number of rotations to be imposed by the data processing engine 14 to the received data signal y, thereby minimising latency in processing the data signals. However, any alternative architecture, for example where rotations to the data signal occur in parallel with updates in the lattice reduction engine, would significantly increase latency in the data signal path. Storage of the control signals in the buffer 30 is therefore advantageous.

Using this two part arrangement, both the zero forcing (ZF) and minimum mean square error (MMSE) forms of LRA MIMO decoding (as per Ponnampalam et al.) can be achieved with this architecture. The MMSE form is implemented by assuming the extended channel model, as described in Ponnampalam et al.

This apparatus architecture is particularly suitable for use in multi-carrier communications systems such as those based on OFDM or OFDMA. In such an implementation, the signals corresponding to each subcarrier can be processed individually. However, it could be preferable to process subcarriers in groups through each block in the detector, as the presently disclosed architecture facilitates.

A specific application benefiting from the use of this architecture would be a Wireless LAN device, such as a WLAN conforming to the IEEE 802.11n standard. This architecture facilitates simple reconfiguration between a lattice-reduction-aided MIMO detector and a corresponding (ZF or MMSE) detector without the lattice reduction stages. This reconfiguration is discussed further in the fifth embodiment which will be described below.

Assuming that lattice reduction is based upon the LLL algorithm (for which the pseudo-code of the complex-valued algorithm is given in “Complexity study of lattice reduction for MIMO detection” (M. Sandell, A. Lillie, D. McNamara, V. Ponnampalam and D. Milford, Proc. IEEE WCNC, March, 2007)), the input matrix H needs to be decomposed into matrices Q and R through a QR decomposition of H. The LLL algorithm then operates on Q and R to produce the outputs Q′, R′ and T, where HT=Q′R′.

In a software implementation of an LRA MIMO detector the outputs of the LLL algorithm (Q′ and R′) can be used directly to equalise the received data signal. However, in a hardware implementation where the application of the Q^{H} rotation to the received data signal is accomplished through a CORDIC process, the outputs of the LLL algorithm are not in a convenient form. That is, the LLL algorithm would explicitly return the entries of the matrix Q. Instead, the CORDIC application block (Data rotation unit 40) in the DPE 14 requires rotation control signals C rather than the explicit values of the Q matrix. It is therefore convenient to reuse the QRD engine 24 to decompose the matrix HT, thereby generating the necessary CORDIC control signals C for the DPE.

As noted above, the present disclosure in one embodiment uses a hardware efficient implementation of the LLL algorithm, which will now be described with reference to FIG. 4. This exemplary embodiment is focused on the application of the architecture generally disclosed in relation to FIG. 1, to a multi-carrier (OFDM) MIMO system. The PPE 12 and DPE 14 are in such circumstances required to operate upon all subcarriers contained within an OFDM symbol.

FIG. 4 shows a schematic diagram of a second example of a PPE 112. The PPE 112 again comprises a QR Decomposition Engine (QRDE) 124 and a lattice reduction processor (LRP) 126, and the example is focused upon the coupling of the QRDE 124 and LRP 126. As described above, a double-pass QRDE method of PPE operation is assumed. This can be summarized by the following three stages:
1. Perform first QR decomposition on the extended channel matrix \tilde{H}, yielding QR=\tilde{H}

This conforms with “MMSE-Based Lattice-Reduction for Near-ML Detection of MIMO Systems” (D. Wubben, R. Bohnke, V. Kuhn and K. Kammeyer, Proc. ITG Workshop on Smart Antennas, 2004).
2. Perform lattice reduction on R yielding \tilde{H}T as well as the other parameters described above.
3. Perform the second QR decomposition on HT yielding: \tilde{Q}\tilde{R}=\tilde{H}T

Upon completion of the second QR decomposition all of the parameters required by the DPE 14 have been obtained.

UK Patent Application 0703184.2, filed by the present applicant, describes a lattice reduction building block. This corresponds with the LRP 126. Further detail concerning the content of that document is given below. The LRP 126 consists of a number of size and basis reduction stages, in a form which will be understood from reading Wubben et al. The number of stages is dependent upon the size of the matrix to be lattice reduced. In the aforementioned UK patent application, it is shown that a number of these LRPs can be concatenated into a chain to form a LRE, which will, given a sufficient number of LRPs (N_{LRP}), yield a lattice reduced matrix with sufficient quality for MIMO detection.

FIG. 4 illustrates how the PPE 112 can be formed using a single QRDE 124 and a single LRP 126 through the use of both an inner and outer feedback loop. Two multiplexers 125, 127 are also shown in the diagram that enable this feedback. These multiplexers, associated memory blocks and flow control modules are embedded within equivalent functional elements to the LRE and CSI storage/multiplex blocks shown in FIG. 1.

The inner loop is employed N_{LRP}-1 times and the outer loop only once. It will be evident to the reader that if the output of the LRP is fed back around the inner loop N_{LRP}-1 times then the output will be the same as having a chain of N_{LRP} LRPs.

It is possible to realize the QRDE in many different ways, for example using complex CORDIC processing as per the Fitton paper referenced above, which has many features that are advantageous for hardware implementation of a QR decomposition.

In order to meet the performance requirements of MIMO OFDM systems such as the IEEE 802.11n WLAN standard, the QR decomposition will be performed on blocks of N subcarriers, where N is less than or equal to the total number of data subcarriers in an OFDM symbol N_{T}. The size of N will have an impact upon the hardware resource utilization and latency of the QRDE irrespective of the exact method by which the QRDE is implemented. Subcarriers will therefore be grouped into G groups where:

$$G = ⌈ \frac{{N}_{T}}{N} ⌉$$

FIG. 5 shows a timing diagram for the operation of the PPE. In the example shown, there are four groups of subcarriers (G=4), with each group containing N subcarriers. For illustration N_{LRP}=3. The groups are indicated by the reference numbers within the lozenges representing subcarriers. The operation for group 1, proceeds as follows:

All subcarriers in group 1 are fed sequentially into the QRDE processor. The exact input format is dependent upon the exact implementation of the QR decomposition. The QR decomposition for each of the N subcarriers is computed and output in parallel format (arrow (a)). Again, the format will be implementation specific (in this example, the output time is a fraction of the input time, without loss of generality).

As indicated by arrow (b), the R matrices for all N subcarriers are passed from the output of the QRDE to the input of the LRP 126. The LRP 126 performs a first iteration on the R matrices (arrow (c)), yielding R and \tilde{H}T. Both R and \tilde{H}T are fed back via the inner loop to the input of the LRP 126 for the first time (d). The LRP then performs a second iteration (e) and, again, both R and \tilde{H}T are fed back via the inner loop to the input of the LRP for the second time (f).

The LRP then performs a third iteration (g), and in this example this is the final iteration. \tilde{H}T is then routed from the output of the LRP to the QRDE input via the outer feedback loop (h). The QRDE performs a second QR decomposition (i) yielding \tilde{Q}and \tilde{R}which are required for the DPE operation described above in relation to FIG. 1.

FIG. 5 also shows the operation for the remaining groups of subcarriers (markers 2, 3 and 4). It can be seen that the groups are temporally interleaved, so that there are no collisions between the groups at any stage in the PPE operation. In order to achieve this, the following timing conditions and constraints must be observed:
The QRDE has a processing latency of T_{QRDE}, which will be a function of N, the QRDE architecture and the matrix size to be decomposed;
The QRDE is capable of accepting the input of the subsequent group of subcarriers before the processing of the previous group is complete. That is, there is some degree of pipelining in the QRDE structure. In the example given in FIG. 3, the input to the QRDE is shown as being continuous;
The period between adjacent output groups is Δ_{QRDE}. This period will be architecture dependent as well as being related to N. Δ_{QRDE} must be constant irrespective of the group number i.e. the QRDE output is regular;
The output of the QRDE is rate matched to the input of the LRP i.e. the LRP can accept data from the QRDE every Δ_{QRDE}. This implies a certain degree of pipelining in the architecture of the LRP;
The processing latency of the LRP is T_{LRP} which results in the period Δ_{LRP} between groups. Δ_{LRP} must also be regular. T_{LRP} must be carefully designed in sympathy with T_{QRDE} so that contention free operation (between the feed forward input to the LRP from the QRDE and feedback on the inner loop) can be achieved as shown. The ratio of T_{QRDE} to T_{LRP} will also place further constraints upon the degree of pipelining that must be present in the architecture of the LRP;

In summary, the degree of pipelining and the throughput of the LRP must be matched to the throughput of the QRDE and the latency of the stages of the detector in order that contention free feedback operation can be achieved.

This embodiment has certain distinctive features enhancing its operation. In particular, it implements an outer loop between the LRP 126 and QRDE 124, which facilitates the use of a single QRDE. It uses an inner feedback loop, which facilitates the implementation of a full LRE using a single LRP 126. Further, the architecture involves the interleaving of feed forward data from the QRDE 124 into the LRP 126 with feedback data, via the inner loop, from the LRP 126.

Rate matching between the QRDE 124 and LRP 126 and pipeline length optimization of both the QRDE 124 and LRP 126 facilitates contention free feedback operation, which maintains the overall throughput of the PPE 112, therefore not compromising the latency of the PPE 112 whilst achieving significant hardware savings.

This embodiment demonstrates a practical method of implementing the PPE for a LRA MIMO detector using a QRDE 124 closely coupled with a single LRP 126. This implementation could be used in a custom hardware solution where the minimization of hardware resource utilization without compromising PPE latency is the main design goal. By closely coupling iterative architecture over a concatenated chain of processor, only one QRDE 124 is required for this implementation. This is enabled via the outer feedback loop. Without this, two QRDE 124 would be required, doubling the hardware resource utilization. Moreover, a single LRP is required to implement the LRE. This is enabled via the inner feedback loop. Without this, N_{LRP} processors would be required.

Given the constraints presented above and the timing diagram shown in FIG. 5, it will be evident to the reader that the overall latency of the PPE is the same for this iterative implementation as it would be for a non iterative design employing multiple QRDEs and LRPs concatenated to form a chain. Therefore, significant hardware savings can be achieved in this iterative implementation without any penalty in the overall processing latency.

A third specific embodiment of the invention is provided to demonstrate hardware implementation of the LLL algorithm with modifications to take account of hardware specific design criteria.

Among the practical disadvantages of the LLL algorithm set out in the introduction, step (5) computes the parameter μ which can be referred to as the ‘update parameter’. Algorithmically, the computation of p involves a division operation. This will therefore be computationally demanding and, even if a simple binary search technique is used to implement this operation, step (5) is not well suited to high speed implementation.

The third embodiment employs a method for reducing the complexity of computing the update parameter μ that is optimized for implementation in hardware. Referring firstly to FIG. 6, a schematic diagram is illustrated of a hardware implementation of an update parameter unit 210. This can perform the computation of the real or imaginary part of μ. The update parameter unit comprises an addition/subtraction function unit 212, receiving either Real or Imaginary parts of \tilde{R}(l,k) and \tilde{R}(l,l). An XOR gate 214 controls whether the addition/subtraction function unit 212 performs an addition or subtraction of its inputs. The XOR gate 214 controls this on the basis of the signs of the two input quantities to the update parameter unit. The result of the XOR operation so performed is in fact the sign of μ.

A comparator 216 is provided, which is configured to compare the output of the addition/subtraction function unit 212 with the input based on \tilde{R}(l, k). The output of this comparison is either 0 or 1, which is the magnitude of μ. Thus, μ is output as a value of 0, +1 or −1.

It can be seen that this update parameter unit 210 contains only a single addition/subtraction function and a comparator as well as logical expressions. This is significantly less complex than the processor required to implement the full computation of μ given in the pseudo code in the introduction.

This processing unit also has the advantage that it is trivial to implement the update of parameters such as R and T as given by lines (7) and (8) in the pseudo code. FIG. 7 shows one possible set of extensions to the unit illustrated in FIG. 6 to achieve this. The unit 310 illustrated in FIG. 7 shares with the update parameter unit 210 an addition/subtraction function unit 312, an XOR gate 314 and a comparator 316. Their specific functions will not need to be discussed further in relation to this embodiment.

In addition, a multiplexer 320 is provided to derive an update of R, which takes as its inputs the output of the addition/subtraction function unit 312 and the initial R(l, k) based input. The multiplexer 320 is controlled by the update parameter μ. Thus, to update R, only a simple multiplexer is required.

Moreover, a further addition/subtraction function unit 322 and another multiplexer 324 are provided, in order to derive an update of T. This addition/subtraction function unit 322 and this further multiplexer 324 are more sophisticated, as they perform column wise operations on the input existing T matrix. Further additions can also be made as will be described in later embodiments of the invention.

The following pseudo code shows the modifications made to the above complex LLL code in the implementation described above and parts of which are illustrated in FIGS. 6 and 7. Operation (5) has been replaced by independent operations for the real and imaginary parts of the update parameter, given by μ_{Re} and μ_{Im} respectively. Both μ_{Re} and μ_{Im} have been limited in range, such that μ_{Re}, μ_{∈{-}1,0,+1}. The IF statement contained on lines 6 and 9 has also been removed as it is redundant in a hardware implementation.

INPUT: Q, R, P (default P = Iₘ)
OUTPUT: \tilde{Q}, \tilde{R}, T

| | |
|---|---|
| (1) | Initialisation: \tilde{Q} = Q, \tilde{R} = R, T = P |
| (2) | k = 2 |
| (3) | while k ≦ m |

| | |
|---|---|
| (4) | for l = k − 1, . . . , 1 |

| | |
|---|---|
| (5a) | if Re{\tilde{R}(l,k)/\tilde{R}(l, l)} > +0.5 |

| | |
|---|---|
| (5b) | μ_{Re} = +1 |

| | |
|---|---|
| (5c) | elseif Re{\tilde{R}(l, k)/\tilde{R}(l, l)} < −0.5 |

| | |
|---|---|
| (5d) | μ_{Re} = −1 |

| | |
|---|---|
| (5e) | else |

| | |
|---|---|
| (5f) | μ_{Re} = 0 |

| | |
|---|---|
| (5g) | end |
| (5h) | if Im{\tilde{R}(l, k)/\tilde{R}(l, l)} > +0.5 |

| | |
|---|---|
| (5i) | μ_{Im} = +1 |

| | |
|---|---|
| (5j) | elseif Im{\tilde{R}(l, k)/\tilde{R}(l,l)} < −0.5 |

| | |
|---|---|
| (5k) | μ_{Im} = −1 |

| | |
|---|---|
| (5l) | else |

| | |
|---|---|
| (5m) | μ_{Im} = 0 |

| | |
|---|---|
| (5n) | end |
| (6) | |

| | |
|---|---|
| (7) | \tilde{R}(1:l, k) = \tilde{R}(1:l, k) − μ\tilde{R}(1:1, 1) |
| (8) | T(;, k) = T(:, k) − μT(:.l) |
| (9) | |

| | |
|---|---|
| (10) | end |

| | |
|---|---|
| (11) | if \|δ\tilde{R}(k − 1, k − 1)²\| > \|\tilde{R}(k, k)²\| + \|\tilde{R}(k − 1, k)²\| |

| | |
|---|---|
| (12) | swap columns k − 1 and k in \tilde{R} and T |
| (13) | calculate Givens rotation matrix Θ such that |

element \tilde{R}(k, k − 1) becomes zero:
$Θ = ( \begin{matrix}{a}^{*} & {b}^{*} \\ - b & a\end{matrix} ) with \begin{matrix}a = \frac{\tilde{R} ( k - 1 , k - 1 )}{‖ \tilde{R} ( k - 1 \text{:} k , k - 1 ) ‖} \\ b = \frac{\tilde{R} ( k , k - 1 )}{‖ \tilde{R} ( k - 1 \text{:} k , k - 1 ) ‖}\end{matrix}$

| | |
|---|---|
| (14) | \tilde{R}(k − 1:k, k − 1:m) = Θ\tilde{R}(k − 1:k, k − 1:m) |
| (15) | \tilde{Q}(:, k − 1:k) = \tilde{Q}(:, k − 1:k)Θ^{H} |
| (16) | k = max{k − 1, 2} |

| | |
|---|---|
| (17) | else |

| | |
|---|---|
| (18) | k = k + 1 |

| | |
|---|---|
| (19) | end |

end

As will be readily understood, the implementation in FIG. 6 reflects lines 5a to 5n of the above algorithm, and lines 7 and 8 are implemented by the additional parts illustrated in FIG. 7.

Significant complexity savings can be made due to the +/−0.5 threshold. This can be evaluated with a simple addition or subtraction and comparison operation, rather than an explicit division and comparison.

The modified pseudo code given above lends itself to a hardware implementation which is distinguished from the basic LLL algorithm described in the introduction, in terms of its simplicity. This has advantages in terms of hardware resources and processing latency.

The limitation of μ∈{−1,0,+1} does not impact upon performance when multiple iterations of a lattice reduction processor are employed in the lattice reduction engine. It should also be noted that, in the LRA MMSE detector described in the first embodiment described above, step 15) of the above algorithm is not required.

FIG. 8 shows a packet error rate (PER) versus signal to noise ratio (SNR) performance graph comparing the modified algorithm described above in terms of the present embodiment with the complex LLL algorithm described in the introduction. The curves are for an IEEE 802.11n MIMO OFDM system with four transmit and four receive antennas. The number of spatial streams is four, 64-QAM modulation and 5/6 rate forward error correction (FEC) coding are employed (this is the highest rate mode of operation for the 802.11n system).

The modified algorithm has been combined with the fixed complexity algorithm described in UK Patent Application 0703184.2, as this represents a viable hardware implementation. Although that document is currently unpublished, the content thereof comprises a description of a lattice reduction aided detector comprising at least one operational unit operable to apply a size reduction operation and/or a basis reduction operation on input data presented as a matrix. A controller is described which allows a looping pipeline to be constructed. The algorithm disclosed in that document can be characterised as follows:

INPUT: Q, R, P (default P = Iₘ)
OUTPUT: \tilde{Q}, \tilde{R}, T

| | |
|---|---|
| (1) | Initialisation: \tilde{Q} = Q, \tilde{R} = R, T = P |
| (2) | for k = 1:m |

| | |
|---|---|
| (3) | for l = k − 1, . . . , 1 |

| | |
|---|---|
| (4) | μ = [symbol] \tilde{R}(l, k)/\tilde{R}(l, l) [symbol] |
| (5) | if μ ≠ 0 |

| | |
|---|---|
| (6) | \tilde{R}(1:l, k) = \tilde{R}(1:l, k) − μ\tilde{R}(1:l, l) |

| | |
|---|---|
| (7) | T(;, k) = T(:, k) − μT(:.l) |

| | |
|---|---|
| (8) | end |

| | |
|---|---|
| (9) | end |

| | |
|---|---|
| (10) | if δ\tilde{R}(k − 1, k − 1)² > \tilde{R}(k, k)² + \tilde{R}(k − 1, k)² |

| | |
|---|---|
| (11) | swap columns k − l and k in \tilde{R} and T |
| (12) | calculate Givens rotation matrix Θ such that |

element \tilde{R}(k, k − 1) becomes zero:
$Θ = ( \begin{matrix}a & b \\ - b & a\end{matrix} ) with \begin{matrix}a = \frac{\tilde{R} ( k - 1 , k - 1 )}{‖ \tilde{R} ( k - 1 \text{:} k , k - 1 ) ‖} \\ b = \frac{\tilde{R} ( k , k - 1 )}{‖ \tilde{R} ( k - 1 \text{:} k , k - 1 ) ‖}\end{matrix}$

| | |
|---|---|
| (13) | \tilde{R}(k − 1:k, k − 1:m) = Θ\tilde{R}(k − 1:k, k − 1:m) |
| (14) | \tilde{Q}(:, k − 1:k) = \tilde{Q}(:, k − 1:k)Θ^{T} |

| | |
|---|---|
| (15) | end |

| | |
|---|---|
| (16) | end |
| (17) | |

It should be noted that the FOR-loop (lines 2-16 above) may be repeated several times to improve performance. The number of lattice reduction (LR) iterations has been set to either 4 or 5. In the case of 4 iterations there is some degradation in performance between the modified algorithm and the original. However, when the number of LR iterations is 5, there is no degradation in performance between the modified version and the original.

In the next embodiment, disclosure will be given of a suitable approach to the provision of an output from the lattice reduction engine representing the matrix product HT. Clearly, one option would be to compute this product by explicit multiplication but, again, matrix multiplication can be costly of hardware resources and can increase latency of a hardware implementation.

For this embodiment of the invention, it is assumed that a lattice reduction algorithm operates on an input matrix H to produce a unimodular output matrix T such that the matrix product HT has a better condition number than the original matrix, H. One example of an algorithm that can achieve this is the LLL algorithm outlined in the introduction to the present disclosure.

The LLL algorithm is iterative, with the matrix T being updated over multiple iterations of the algorithm until a stopping criterion is satisfied.

The lattice reduction algorithm can be modified so that it computes and outputs the matrix product HT through the following steps:
1. T is initialised to be the identity matrix.
2. HT is initialised to be equal to H.
3. For every update that the lattice reduction algorithm makes to the matrix T, the identical update is made to HT. e.g.:
   a. If the n^{th} column of T is updated to be a linear combination of the p^{th} and Q^{th} columns of T, then the nth column of HT is updated to be the same linear combination of the p^{th} and q^{th} columns of HT.
   b. If the p^{th} and q^{th} columns of T are swapped, then the p^{th} and q^{th} columns of HT are swapped.

If these modifications are made to the algorithm described in the introduction, the following modified LLL algorithm is obtained:

INPUT: Q, R, H
OUTPUT: \tilde{Q}, \tilde{R}, T, HT

| | |
|---|---|
| (1) | Initialisation: \tilde{Q} = Q, \tilde{R} = R, T = I, HT = H |
| (2) | k = 2 |
| (3) | while k ≦ m |

| | |
|---|---|
| (4) | for l = k − 1, . . . , 1 |

| | |
|---|---|
| (5) | μ = [symbol] \tilde{R}(l, k)/\tilde{R}(l, l) [symbol] |
| (6) | if μ ≠ 0 |

| | |
|---|---|
| (7) | \tilde{R}(1:l, k) = \tilde{R}(1:l, k) − μ\tilde{R}(1:l, l) |
| (8) | T(:, k) = T(:, k) − μT(:, l) |

| | |
|---|---|
| a. | HT(:, k) = HT(:, k) − μHT(:, l) |

| | |
|---|---|
| (9) | end |

| | |
|---|---|
| (10) | end |
| (11) | if \|δ\tilde{R}(k − 1, k − 1)²\| > \|\tilde{R}(k, k)²\| + \|\tilde{R}(k − 1, k)²\| |

| | |
|---|---|
| (12) | swap columns k − l and k in \tilde{R} and T and HT |
| (13) | calculate Givens rotation matrix Θ such that |

element \tilde{R}(k, k − 1) becomes zero:
$Θ = ( \begin{matrix}{a}^{*} & {b}^{*} \\ - b & a\end{matrix} ) with \begin{matrix}a = \frac{\tilde{R} ( k - 1 , k - 1 )}{‖ \tilde{R} ( k - 1 \text{:} k , k - 1 ) ‖} \\ b = \frac{\tilde{R} ( k , k - 1 )}{‖ \tilde{R} ( k - 1 \text{:} k , k - 1 ) ‖}\end{matrix}$

| | |
|---|---|
| (14) | \tilde{R}(k − 1:k, k − 1:m) = Θ\tilde{R}(k − 1:k, k − 1:m) |
| (15) | \tilde{Q}(:, k − 1:k) = \tilde{Q}(:, k − 1:k)Θ^{H} |
| (16) | k = max{k − 1, 2} |

| | |
|---|---|
| (17) | else |

| | |
|---|---|
| (18) | k = k + 1 |

| | |
|---|---|
| (19) | end |

| | |
|---|---|
| (20) | end |

The modifications to the base LLL algorithm are that H is included as an input, and HT as an output. An additional operation (line 8a indicated above) tracks column addition operations made to T, to HT. Given that T is initially the identity matrix, and that HT is initialised to H, HT develops to a final state corresponding to development of T. Similarly, in line 12, column swaps made to T are correspondingly made to HT, with the same outcome.

It will be appreciated that the above modifications to the LLL algorithm could be applied in a similar manner to other variations of this algorithm, or alternate lattice reduction algorithms.

It will also be appreciated that this approach may not be the most computationally efficient solution in all cases, but it lends itself to more effective hardware implementation. Moreover, it is demonstrated above that this approach is as appropriate to an unconstrained update parameter μ as it would be to an approach using a constrained update parameter, as used in the preceding embodiment. Thus, the two embodiments can be combined, or used separately. Indeed, FIG. 9 illustrates implementation of the two approaches in the fourth embodiment of the invention. The arrangement illustrated in FIG. 9 includes the same components as illustrated in FIG. 7 but, additionally, a yet further addition/subtraction function unit 422 and another multiplexer 424 are provided, in order to derive an update of HT. Operation of this addition/subtraction function unit 422 and this further multiplexer 424 follow operation of the addition/subtraction function unit 322 and the multiplexer 324 for T, performing the same column wise operations on the input existing H matrix to form HT.

When this embodiment is employed, and combined with the modifications to step 5 illustrated by the third embodiment described above, wherein the value of μ is constrained to be −1, 0 or +1, the new step (8a) in the modified algorithm above can be implemented with simple addition or subtraction operations and so avoids the requirement for any multiplication operations (such as of μ with HT).

A fifth embodiment will now be described. This contains modifications to the design presented in the first specific embodiment illustrated above, but it will be appreciated by the reader that equivalent modifications could be made to any of the other embodiments in the same way.

As noted above, various algorithms exist for MINO detectors. These all vary in their performance and complexity. Common choices for implementation are the zero-forcing (ZF) or minimum mean square error (MMSE) solutions, due to their practicability. Non-linear detectors offer higher performance, however the complexity of the optimal maximum likelihood (ML) solution is usually prohibitively complex in all but the most trivial system configurations. There is therefore significant motivation to use a sub-optimum detector that can achieve a good performance gain over the linear ZF or MMSE solutions whilst still being capable of being implemented in a practical device.

As noted above, the architecture of FIG. 1 could be employed for any type of communication system. However, this embodiment is focused upon its application to a multi-carrier (OFDM) MIMO system. The PPE and DPE are required to operate upon all subcarriers contained within an OFDM symbol.

The specifications for wireless communications standards often impose rigorous constraints upon the latency of the receiver. Generally, it is desirable for the receiver to support ‘real time reception’. For the purposes of this embodiment, ‘real time’ should be considered, for the MIMO detector in an OFDM based system, to mean that data carrying OFDM symbols are processed immediately and are not queued in a buffer prior to detection, whilst the preceding symbol(s) are detected.

The LRA MMSE detector of the first specific embodiment may not, in all practical circumstances, support true real-time operation unless impractical and or undesirable clock frequencies are employed for the detector. This is due to the latency of the PPE, which will generally be updated once per received packet. This embodiment sets out to provide improved operation in this particular mode of operation.

It is also desirable for the packet error rate (PER) performance of the receiver to be optimized for all operating scenarios. Under certain operating conditions and with certain system configurations the LRA MMSE detector can have inferior performance to a standard MMSE detector. This embodiment sets out to provide improved operation in this particular mode of operation.

As illustrated in FIG. 10, an LRA MIMO detector 800 is identical to that shown in FIG. 1 but reconfigured to perform standard ZF or MMSE detection (as the case may be), with only minor modifications and additions. Throughout description of this embodiment, MMSE could be substituted for ZF detection. FIG. 10 shows a block diagram of the detector reconfigured to perform MMSE detection (the unused parts of the LRA MMSE detector are illustrated in broken line for clarity). This takes account of the fact that, for standard ZF or MMSE detection:
The LRE is not required for MMSE detection and is therefore disabled;
The QRDE only performs a single decomposition of the extended channel matrix, with its outputs fed directly to the C and R storage blocks after the first pass;
The row-sum parity vector (p) and T matrix are not required for MMSE detection;
The scaling operation present in the back substitution processing block must be adapted for MMSE detection rather than performing the scaling operation required for LRA MMSE detection; and
The soft output processor in the DPE computes log likelihood ratios in the standard way for an MMSE detector, for example using a Euclidean distance metric, rather than using the methods disclosed in GB2429884A1, US2007/0206697A1 and Ponnampalam et al.

It is therefore possible for this MIMO detector to be reconfigured to employ either LRA MMSE or MMSE detection on a per-received-packet basis in order to optimize the receiver performance.

There are two differences between the LRA MMSE detector and a standard MMSE detector, namely PER performance and PPE processing time (latency).

In general, the PER performance of the LRA MMSE detector is superior to that of the MMSE detector for a given modulation and coding scheme (MCS) selection. However, under certain operating conditions and with certain MCS selections the performance of the LRA MMSE detector performance can be inferior to the performance of the MMSE detector.

In order to optimize PER performance, the most appropriate detector can be selected based upon the current MCS mode, which is known prior to MIMO detection in the receiver. One example of when the MMSE detector will always outperform the LRA MMSE detector is the case where there is only a single spatial stream transmitted, irrespective of the number of transmit and receive antennas. In IEEE 802.11n systems, this is MCS 0-7.

The PPE processing time for the LRA MMSE detector will be substantially greater for the LRA MMSE detector than for the MMSE detector. This is due to the second QR decomposition and lattice reduction processing performed for LRA MMSE detection.

It will be understood that the above referenced processing, decision making and “switching in or out” of functionality will be performed, in a suitable implementation, by a hardware controller (such as a microprocessor) of suitable configuration. Such a microprocessor has been omitted from FIG. 10 for clarity, to highlight the similarity between the detector of FIG. 10 and that of FIG. 1.

FIG. 11 shows a timing diagram for the operation of both the LRA MMSE detector and a standard MMSE detector. The top line of the figure shows received OFDM symbols post FFT processing in the receiver. All other post FFT receiver functionality has been omitted for clarity. In this example, without loss of generality, the first four received symbols (labelled H1-H4) are header symbols containing training data. Following this, there are seven OFDM symbols containing data (labelled D1-D7).

These symbols are periodic, with period T_{OFDM}. An example of a system employing this type of structure is that specified in the IEEE 802.11n WLAN standard.

The training symbols are required by the PPE, as the channel estimate, input to the PPE, is obtained from these symbols. The PPE does not start processing until these training symbols have been completely received. In fact, the PPE may not start to process until some time later due to the overhead of channel estimation. The PPE for the LRA MMSE takes T_{PPE LRA} to complete (shown on line 2) and requires T_{PPE MMSE} to complete for the MMSE detector (shown on line 4). T_{PPE LRA} is significantly greater than T_{PPE MMSE}. In this example, T_{PPE LRA} is greater than T_{OFDM} and T_{PPE MMSE} is equal to T_{OFDM}.

Data detection, performed by the DPE, on a per received data OFDM symbol cannot start until after the PPE has completed its preparatory operations. In order to achieve real-time operation, the processing time of the DPE (T_{DPE}) must be less than T_{OFDM}, otherwise a back-log of data OFDM symbols will build up at the input to the DPE. It can be assumed, without loss of generality, that T_{DPE} is equal for both MIMO detectors.

Examining first the operation of the MMSE detector, it can be seen that the data detection (shown on line 5) is always real-time. As soon as a complete OFDM symbol is present at the DPE input, it is processed, without having to be queued. This real-time operation will always be true and is irrespective of the number of OFDM data symbols present in the received packet.

Examining the operation of the LRA MMSE data detection, it can be seen that there are two phases of operation, namely a non-real-time phase, and a real-time phase. The non-real-time phase is characterised by data OFDM symbols queued in a buffer at the DPE input. These data symbols are detected as quickly as possible, in an attempt to clear the back-log. When the back-log is cleared, the detector enters the real-time phase of operation, in which all OFDM symbols are processed immediately.

In the illustrated example, five data symbols (labelled L1-L5) are processed in non-real time, before the back-log is cleared and the real-time phase of operation begins. The length of the non-real-time phase depends upon the ratio of T_{PPE LRA} to T_{OFDM}.

Assuming that the detector reaches the real-time phase of operation following a period of non-real-time operation, the detector can be classified as ‘pseudo-real-time’. This pseudo-real-time operation is perfectly acceptable as overall receiver latency is not compromised.

If the received packet contains fewer data OFDM symbols than are required to clear the PPE back-log, then the operation of the detector will never enter the real-time phase of operation and will be classified as non-real-time. This is unacceptable, as the overall receiver latency will be compromised. The receiver may still be processing OFDM symbols when the next OFDM packet is received, which will seriously impact on the ability of the receiver to process data at a suitable rate.

Therefore, the choice of MIMO detector should be made on the basis of the length of the received packet (which is known prior to MIMO detection). Generally, the length of the data portion of the received packet is known to the receiver in bytes. Given that the MCS mode is also known, it is trivial to map this back to the number of data OFDM symbols. If the number of data OFDM symbols exceeds the threshold required to clear the PPE back-log then _{LRA} MMSE detection should be selected, otherwise MMSE detection should be selected.

It is possible to combine both of the presented optimization criteria, which are based upon PER performance and received packet size. FIG. 12 shows a flow diagram setting out an example of a method which can be performed by the receiver for this purpose. This flow diagram presents a method which has a deliberate bias towards real-time operation, which is vital in order that overall receiver latency is not compromised.

The method as described commences, in step S2, with a determination of the number N of OFDM data symbols (indicated DX in FIG. 10) carried in the incoming packet. Then, in step S4, N is compared with a threshold, predetermined for the receiver given its processing capability and, if N is beneath or equal to the threshold, MMSE detection is designated. That is, in accordance with FIG. 9, the parts of the receiver supporting RL aided MMSE detection are disabled. Step S6 executes MMSE detection in this form.

If N exceeds the threshold then, in step S8, the PER for RL aided MMSE is compared with that for MMSE without the RL aided facility. If the PER for RL aided MMSE is lower than without lattice reduction, then the process proceeds to step S6. Otherwise, the process determines that there is benefit in proceeding with RL aided MMSE and, in step S10, such detection is executed. After either S6 or S10, the detection process terminates until initiated again for the next packet.

In summary, this embodiment provides a reconfigurable MIMO detector, capable of supporting _{LRA} MMSE and MMSE detection, incorporating a metric based on PER performance influencing the detector choice. Other influences on detector choice include a packet size metric. These two metrics can be combined in making a detector choice, as described above or, as will be appreciated by the reader, a detector could be chosen on the basis of one or other of these metrics. Other metrics could also be provided, making an assessment of the usefulness of including lattice reduction and the propensity for OFDM symbols to back up in the detector so as to run the risk of non-real-time detection arising.

From the above five embodiments of the invention, the reader will appreciate that the invention, in all its aspects, can be applied to a number of different embodiments with variations on the above described specific features. In particular, the reader will understand that the specific embodiments are not intended to limit the scope of protection but merely to set out ways in which the invention can be implemented. The scope of protection sought should be read from the claims appended hereto.

1. A lattice reduction aided MIMO detector operable to detect information in a packet based signal comprising a header and one or more data symbols, the detector comprising a pre-processing section operable to derive channel decoding information on the basis of a channel estimate from said header, storage means operable to store said channel decoding information, and a data processing section operable to process said one or more data symbols with reference to said stored channel decoding information.

2. A detector in accordance with claim 1 wherein said pre-processing section is operable to generate information enabling the data processing section to equalise a received data symbol in a reduced lattice.

3. A detector in accordance with claim 1 wherein the pre-processing section comprises first QR decomposition means operable to decompose a channel state matrix representative of an estimate of the channel on which said received signal for decoding has been transmitted, and to derive R component information representative of an R component of said decomposition of said channel state matrix, and wherein said pre-processing section comprises lattice reduction means operable to process said R component information from said first QR decomposition means, to derive a reduced lattice channel estimate, the pre-processing section being operable to output to said storage means, as channel decoding information, information describing the lattice reduction derived by the lattice reduction means.

4. A detector in accordance with claim 3 and further comprising second QR decomposition means operable to derive Q component information representative of a Q component of said decomposition of said reduced lattice channel state matrix and R component information representative of an R component of said decomposition of said reduced lattice channel state matrix, said pre-processing section being operable to output said Q component information and said R component information to said storage means for storage as channel decoding information.

5. A detector in accordance with claim 4 wherein said data processing section is implemented by way of CORDIC processing means and said Q component information comprises CORDIC control information for use in said data processing section for application of one or more rotations by said CORDIC processing means to said received data symbol or symbols in accordance with said channel estimate.

6. A detector in accordance with claim 4, comprising a QR decomposition unit, and further comprising feedback means operable to feed back said reduced lattice channel state matrix from said lattice reduction means to said QR decomposition unit, such that said QR decomposition unit can provide said first and second QR decomposition means.

7. A detector in accordance with claim 1 wherein said pre-processing section is employed on receipt of a header of a packet on said channel, said header comprising training information from which a channel estimate can be derived, and wherein said data processing section is operable to process each subsequent data symbol following said header using the stored channel decoding information until another header is encountered.

8. A detector in accordance with claim 1 operable to output soft information, said soft information providing a measure of the certainty with which said detector assigns a value to data detected in said received symbols.

9. A receiver comprising a detector in accordance with claim 1.

10. A method of detecting information in a packet based signal comprising a header and one or more data symbols, the method comprising pre-processing, said pre-processing including deriving channel decoding information on the basis of a channel estimate from said header, said channel decoding information enabling equalisation of data symbols in a reduced lattice, storing said channel decoding information, and processing said one or more data symbols with reference to said stored channel decoding information.

11. A method in accordance with claim 10 wherein the pre-processing comprises a first QR decomposition step including decomposing a channel state matrix representative of an estimate of the channel on which said received signal for decoding has been transmitted, deriving R component information representative of an R component of said decomposition of said channel state matrix, processing said R component information from said first QR decomposition means to derive a reduced lattice channel estimate, and outputting, for storage in said storing, information describing the lattice reduction.

12. A method in accordance with claim 11 and further comprising a second QR decomposition step including deriving Q component information representative of a Q component of said decomposition of said reduced lattice channel state matrix and R component information representative of an R component of said decomposition of said reduced lattice channel state matrix, and outputting, for storage in said storing, said Q component information and said R component information.

13. A method in accordance with claim 12 wherein said data processing is performed by CORDIC processing means and said Q component information comprises CORDIC control information for use in said data processing for application of one or more rotations by said CORDIC processing means to said received data symbol or symbols in accordance with said channel estimate.

14. A method in accordance with claim 12, in which said first QR decomposition step is performed by a QR decomposition unit, the method comprising feeding back said reduced lattice channel state matrix from said lattice reduction means to said QR decomposition unit, such that said second QR decomposition step is performed on the same QR decomposition unit as the first.

15. A method in accordance with claim 10 wherein said pre-processing is performed on receipt of a header of a packet on said channel, said header comprising training information from which a channel estimate can be derived, and wherein said data processing comprises processing each subsequent data symbol following said header using the stored channel decoding information until another header is encountered.
